(19) United States
(12) Patent Application Publication
(10) Pub. No.: US 2006/0290321 A1
(43) Pub. Date: Dec. 28, 2006

(54) System and method for supplying power to a device during battery replacement

(75) Inventors: Kulvir Singh Bhogal, Fort Worth, TX (US); Gregory Jensen Boss, American Fork, UT (US); Rick Allen Hamilton II, Charlottesville, VA (US); Alexandre Polozoff, Bloomington, IL (US)

Correspondence Address: DUKE W. YEE;YEE & ASSOCIATES, P.C., P.O. BOX 802333, DALLAS, TX, 75380, US

(73) Assignee: Lenovo (Singapore) Pte. Ltd., Singapore (SG)

(21) Appl. No.: 11/168,186

(22) Filed: Jun. 28, 2005

(51) Int. Cl. H02J 7/00

(52) U.S. Cl. 320/128

(57) ABSTRACT

A system and method are provided for supplying a specified minimum level of power to a laptop computer or other device during a battery replacement procedure. In the system, a first battery has a plurality of terminal pairs, each terminal pair comprising positive and negative terminals. The system further includes a battery interface comprising two pairs of contact points, the contact points of each pair adapted to engage corresponding terminals of one of the terminal pairs to couple power from the first battery to the laptop. The power provided to the device by either of the terminal pairs is sufficient to supply the specified minimum level of power. A structure is configured to selectively support the first battery in both normal operating and battery exchange positions, with respect to the battery interface, so that the terminals of at least one terminal pair are always engaged with contact points of a contact pair when the first battery is in the normal operating or the exchange position, or is being moved therebetween. A second battery, substantially identical to the first battery, is adapted for placement with respect to the structure to bring terminals of a terminal pair of the second battery into engagement with contacts of one of the contact pairs, when the first battery is in the battery exchange position.

### BACKGROUND OF THE INVENTION

1. Field of the Invention

The invention disclosed and claimed herein generally pertains to a system and method for replacing a battery in a battery operated device. More particularly, the invention pertains to a system of the above type that ensures continual supply of a minimum level of power during the battery replacement procedure. Even more particularly, the invention pertains to a system of the above type for use with an electronic device such as a laptop computer, a wireless telephone or other device, wherein even a brief interruption in battery supplied power could have undesirable consequences.

2. Description of the Related Art

A large portion of employees in today's work force use laptop computers as their primary workstations. The advantage of supplying employees with laptop computers lies in the mobility that laptops generally afford, due to their small size and self-contained power source. Recharged laptop batteries that are new will typically last several hours, although after a year or two of use, depending on conditions such as shocks, usage and memory effects, usable time of a recharged battery will often drop by as much as one-half. Moreover, most batteries on the market, even when new, do not last long enough to meet the needs of many end users. Accordingly, a significant portion of those using laptops will keep multiple batteries available. However, when laptop users swap out or replace their batteries, they typically have to shut down their computers, or alternatively must enter hibernation. Accordingly, in order to save work in process, a user may have to go through a lengthy process of application and operating system shutdown, and then wait until the laptop reboots. This process is inefficient and can waste as much as ten minutes.

It will be understood that battery replacement methods are very important in the operation of other devices besides laptop computers. Such devices may include cell phones, Personal Digital Assistants (PDAs), toys and flashlights. Regarding cellular phones, cellular telephone manufacturers usually offer users the option to buy additional batteries. It may be necessary to keep multiple batteries readily available, if heavy phone use is anticipated. However, it is generally necessary for a phone to be shut down or turned off in order to replace a battery, particularly if an AC adapter and an electric outlet are not available. This also pertains to PDAs. In addition, PDAs and most hybrid PDA/cell phone devices have significant boot up times. Thus, replacing batteries on these devices tends to be a time-consuming process, in like manner with laptops, and generally does not allow a phone conversation already underway to continue.

In the past, laptop manufacturers have attempted to minimize disruption to the end user, caused by battery replacement, by actions such as the following: (1) Providing a secondary battery compartment in the laptop; (2) Providing a means to enter hibernation; and (3) Providing complicated security and internal backup batteries to maintain a standby or suspend state. Each of these approaches of the prior art, together with drawbacks and disadvantages resulting from their use, is described hereinafter in further detail. One significant disadvantage found in these approaches is requiring batteries that can add significant weight to laptops, thereby reducing laptop mobility. These prior art approaches may also require additional expensive internal circuitry, or may require a lengthy shutdown and startup period.

### BRIEF SUMMARY OF THE INVENTION

Embodiments of the invention enable the users of laptop computers, or other devices of the type described above, to replace batteries without having to shut down, or to go into hibernation. To the contrary, the invention enables a laptop or other battery powered device to remain fully powered during the entire battery replacement procedure, thereby increasing user productivity. Moreover, it is unnecessary to suspend a laptop to accommodate weak internal reserve batteries. Embodiments of the invention also eliminate expensive circuitry and internal reserve batteries, and any components that tend to make the laptop significantly heavier. In one embodiment, the invention is directed to a system for continuously providing a specified minimum level of power to a device during battery replacement. The system includes a first battery having a plurality of terminal pairs, each terminal pair comprising positive and negative terminals. The system further includes a battery interface comprising two or more pairs of contact points, the contact points of each contact pair adapted to engage corresponding terminals of one of the terminal pairs to couple power from the first battery to the device. The power provided to the device by any one of the terminal pairs is sufficient to supply the specified minimum level of power. A structure is configured to selectively support the first battery, in both normal operating and battery exchange positions with respect to the battery interface, so that the terminals of at least one terminal pair are always engaged with contact points of a contact pair when the first battery is, respectively, in the normal operating position, in the battery exchange position, or is being moved therebetween. A second battery, substantially identical to the first battery, is adapted for placement with respect to the structure to bring terminals of a terminal pair of the second battery into engagement with contacts of one of the contact pairs, when the first battery is in the battery exchange position.

### BRIEF DESCRIPTION OF THE SEVERAL VIEWS OF THE DRAWINGS

FIG. 1 is a perspective view showing a laptop computer in an inverted position, a battery compartment formed in the underside of the laptop including components for implementing an embodiment of the invention.

FIG. 2 is a perspective view showing a first battery adapted for insertion into the battery compartment of FIG. 1 in order to implement an embodiment of the invention.

FIG. 3 is an end view showing the first battery in a normal operating position.

FIG. 4 is an end view showing the first battery moved to a first battery exchange position.

FIG. 5 is an end view that shows the first battery in the first battery exchange position, and further shows a second battery inserted into the battery compartment in a second battery exchange position.

FIG. 6 is an end view showing the first battery being removed from the battery compartment.

FIG. 7 shows the second battery moved from the second exchange position to the normal operating position.

FIG. 8 is a perspective view showing a laptop computer and battery provided with respective components for implementing a latch mechanism in accordance with embodiments of the invention.

FIGS. 9-11 are schematic diagrams, showing sectioned or cutaway perspective views, to illustrate a modification of the embodiment of the invention shown in FIGS. 3-7.

### DETAILED DESCRIPTION OF THE INVENTION

As stated above, one prior art approach, for reducing disruptions in a laptop during battery replacement, is to provide a secondary battery compartment. On many laptops, such as some provided by the International Business Machines Corporation (IBM), the user can purchase a second battery to fit into the compartment where a CD-ROM normally goes. This allows two batteries capable of supplying power to the laptop at the same time. Thus, a user can remove a low or dead battery and replace it with a third battery. A disadvantage with this is that the batteries frequently are not identical, so that flexibility is sacrificed. For example, if the CD-ROM or DVD-ROM is needed, but only a superbay battery is available, then the CD-ROM cannot be used. Moreover, three batteries are required to swap out the main or primary battery (two primary batteries and one superbay or secondary battery). As a further disadvantage, a substantial amount of additional weight (i.e. a third battery) generally must be carried around with the laptop.

The second approach described above is to provide a means to enter hibernation. Hibernation is a technology that involves copying out the entire contents of the laptop RAM, and making a permanent copy thereof in a file on the hard drive. This enables power to be severed completely. Then, upon rebooting, the operating system will restore the memory image to RAM and return the computer to the exact state it had before battery replacement. However, a disadvantage with this approach is that it requires a lengthy shutdown and startup process, which could take on the order of ten minutes. During this period the concentration and focus of the user on the tasks that were being worked on tends to be disrupted. Moreover, as the amount of memory (RAM) on portable devices increases, the hibernation process becomes slower and slower. For example, it is not uncommon to have one gigabyte of RAM in a laptop, which can take a significant amount of time to copy to a temporary file. In this example, one gigabyte of disk space is lost to the operator of the laptop. This can become an increasing problem over time.

Various models of older computer devices, such as the IBM Thinkpad 770, allowed a user to completely remove the battery and replace it with a second battery without losing power. In such devices, there was a small permanent internal battery that always maintained a charge (enough for about five minutes of standby power). As soon as the replacement battery was inserted, the internal battery was automatically recharged. However, the user was required to be in a “suspend” mode in order to exchange the battery. Moreover, use of the internal battery required additional complicated circuitry, and additional batteries had to be permanently housed in the laptop computer. The addition of more circuitry and battery components introduced more cost and added weight to the laptop. This runs counter to the usual intent in designing laptops and other portable electronic devices, which is to make them small and compact, and of as little weight as possible.

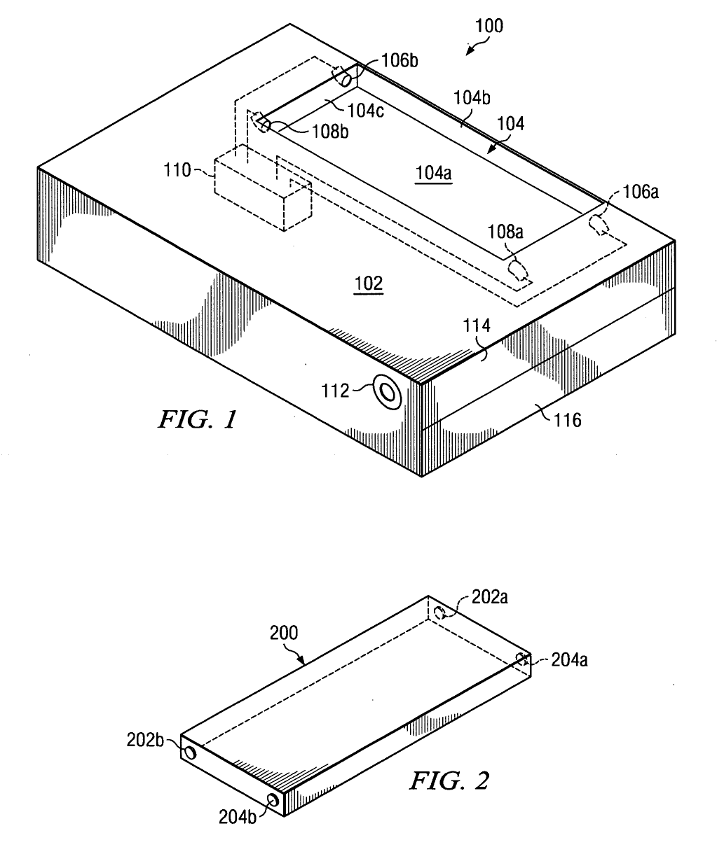

It is considered that embodiments of the invention can be provided which substantially overcome all the disadvantages of the respective prior art approaches discussed above. Referring to FIG. 1, there is shown a laptop computer 100 in an inverted mode. That is, laptop 100 is oriented so that its underside, or bottom surface 102 is directed upwardly, as viewed in FIG. 1. FIG. 1 further shows walls or surface members, such as walls 104a-104c, which are provided at the underside of laptop computer 100 to collectively form or define a battery compartment 104.

Referring further to FIG. 1, there is shown a pair of contact points 106a and 106b fixably positioned at opposing ends of battery compartment 104. Contact point 106a is intended to engage, or conductively connect with, the positive terminal or contact point of a battery inserted into compartment 104. In like manner, contact point 106b is intended to engage with the corresponding negative terminal of the battery. Thus, power at a specified voltage level may be supplied to laptop computer 100 through contacts 106a and 106b.

In like manner, the pair of contact points 108a and 108b are positioned at opposing ends of battery compartment 104, also to engage positive and negative terminals, respectively, of a battery. Accordingly, power at a specified voltage level may also be supplied to laptop 100 through contacts 108a and 108b.

FIG. 1 shows a device 110, comprising power control electronics, connected to both contact points 106a and 106b and contact points 108a and 108b. As described hereinafter in further detail, device 110 is configured to receive battery-supplied power through respective contact points, and to make the received power available for the operational needs of laptop 100.

FIG. 1 further shows a power receptacle 112 for receiving an AC power cord to supply power to laptop 100, in the event that an AC source is available. Laptop 100 usefully comprises components 114 and 116, shown folded together in FIG. 1. Typically, component 114 would contain the keyboard (not shown) for laptop computer 100, and component 116 would be provided with the display therefor.

Referring to FIG. 2, there is shown a battery 200 configured for insertion into battery compartment 104 of laptop 100. Battery 200 is provided with multiple pairs of terminals or contacts. More particularly, battery 200 comprises a first pair of terminals 202a and 202b, and a second pair of terminals 204a and 204b. Terminals 202a and 204a are at a positive voltage, and terminals 202b and 204b are negative terminals. Moreover, the dimensions of battery 200, and the locations of respective battery terminals, are judiciously selected with respect to the size of compartment 104 and the locations of contact pairs 106a-b and 108a-b. The selection is such that battery 200 may readily be inserted into compartment 104 to bring terminals 202a and 202b into close, conductive engagement with contact points 106a and 106b, respectively. In like manner, terminals 204a and 204b may be readily brought into conducting engagement with contact points 108a and 108b, respectively.

Usefully, terminals 202a-b and 204a-b are respectively spring-loaded, or else comprise resilient members of a type well known in the art. Such construction enables respective terminals of battery 200 to be easily moved into and out of engagement with their corresponding contact points, while maintaining good conductivity between engaged terminals and corresponding contact points.

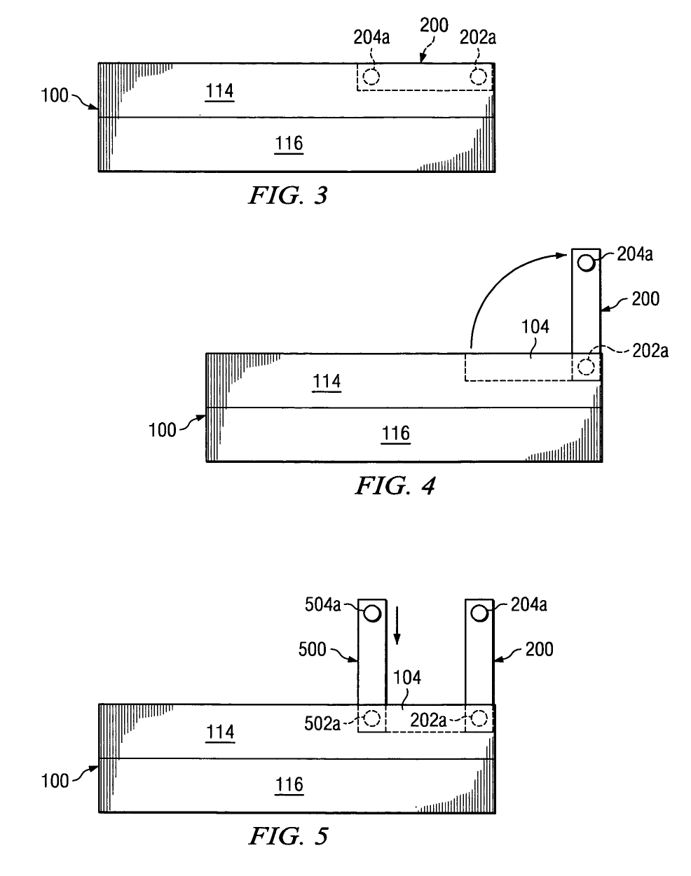

Referring to FIG. 3, there is shown battery 200 fully inserted into compartment 104 of laptop computer 100. Terminals 202a and 202b engage contact points 106a and 106b, respectively, and thus provide power to laptop 100 at a specified voltage level. One typical value for such voltage, for example, would be on the order of 16 volts. In like manner, terminals 204a-b engage contact points 108a-b, respectively, to provide power to laptop computer 100 along an additional path, also at a level of 16 volts. Battery 200 is considered to be in a normal operating position, when positioned in battery compartment 104 as shown in FIG. 3.

While not shown in FIG. 1, a battery compartment cover would usefully be provided to securely retain and protect battery 200 when the battery is in compartment 104, as shown in FIG. 3. The cover would preferably form a flush, continual surface with underside surface 102 of laptop computer 100, and would firmly close off the battery compartment 104.

FIGS. 4-7 illustrate successive steps that are carried out, in order to replace battery 200 with a similar battery, in accordance with an embodiment of the invention. Throughout the replacement procedure, battery power is continuously provided to meet the normal operating needs of the laptop computer. Accordingly, the laptop does not need to be shut down, nor does it need to enter hibernation or go into a suspension or standby mode.

FIG. 4 shows the first step of the battery replacement procedure. Battery 200 is rotated 90 degrees in a clockwise direction, as viewed in FIG. 4, into a battery exchange position. Terminals 204a and 204b are thus moved out of engagement with their respective contact points. However, the rotation takes place about an axis passing through terminals 202a and 202b, and also through contact points 106a and 106b. Thus, terminals 202a and 202b remain engaged or connected to their respective contact points as battery 200 is being moved to the battery exchange position. The terminals 202a and 202b also remain engaged after the battery arrives at such position. The power supplied to laptop computer 100 by battery terminals 202a and 202b, through contact points 106a and 106b, will be sufficient to maintain normal operation of the laptop 100.

Referring to FIG. 5, there is shown a battery 500 that is substantially identical to battery 200. Thus, battery 500 has terminals 502a and 504a that are substantially identical to positive battery terminals 202a and 204a, respectively. Battery 500 also has negative terminals (not shown) that are substantially identical to battery terminals 202b and 204b. FIG. 5 shows battery 500 inserted into battery compartment 104 to bring terminal 502a and its corresponding negative terminal (not shown) into conductive engagement with contact points 108a and 108b, respectively. Thus, in the configuration shown in FIG. 5, power is supplied to laptop 100 by means of two paths. One path is supplied by battery 200 and passes through contact points 106a and 106b. The other path, supplied by battery 500, passes through contact points 108a and 108b. Both of the paths will be at 16 volts, unless battery 200, which is being replaced, has had its voltage level substantially reduced by its prior use.

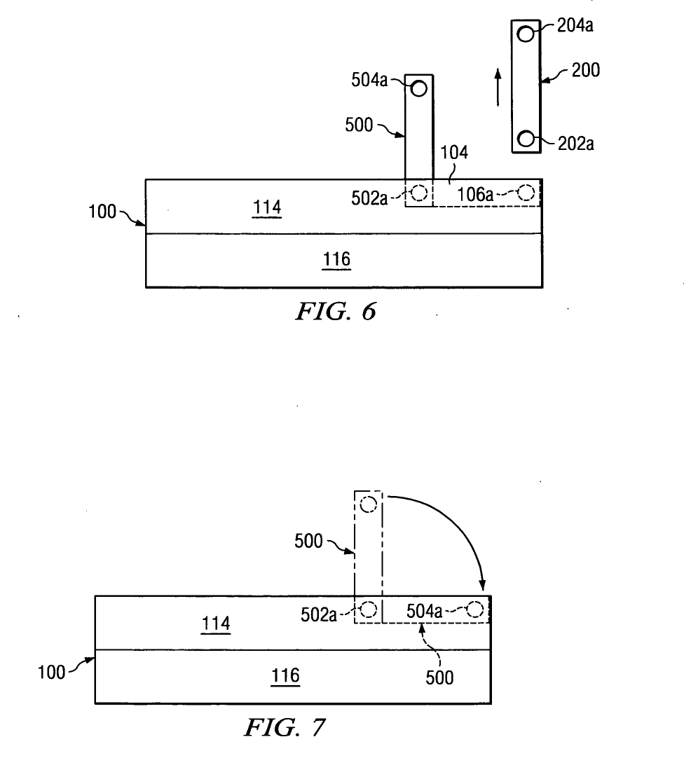

Referring to FIG. 6, there is shown battery 200 being removed completely from battery compartment 104. Thus, power is now supplied to laptop computer 100 only by replacement battery 500, through contact points 108a and 108b.

Referring to FIG. 7, there is shown replacement battery 500 rotated into the normal operating position. In this position, battery 500 is capable of supplying power to laptop 100 through both contact point pairs 106a-b and 108a-b, in like manner with battery 200 as shown in FIG. 3.

From the above description, it will be seen that processing device 110 will receive battery power from varying sources, and over varying paths. At some times, device 110 will receive power over a single path, either through the contact points 106a and 106b, or contact points 108a and 108b. At other times, two paths will supply power, one through each pair of contact points. Also, power will at different times be provided by battery 200, which is being replaced, by replacement battery 500, or by both batteries together, as shown by FIG. 5. Moreover, the voltage levels of respective paths may be at 16 volts or at other rated voltage level of the batteries. However, if battery 200 is being replaced after long use, its actual voltage may have become substantially less than the voltage of new replacement battery 500.

In order to adapt to the varying supply of battery power, device 110 is usefully configured to include a voltage detector for each path, and relays to select one or both paths, as required for continually changing conditions. Device 110 could also be provided with a comparator, to continually compare the voltages of the two paths routed through contact points 106a-b and 108a-b. In one mode of operation, power would be provided by the battery being replaced, until that voltage drops below a critical threshold (which would be 0 volts at the time the battery is removed from the laptop). Alternatively, power would be provided along the path with the higher voltage, as long as that voltage is within normal limits. When only a single battery is in the laptop battery compartment, as shown by FIGS. 3 and 7, power could either be supplied via both paths, or from just one of the paths.

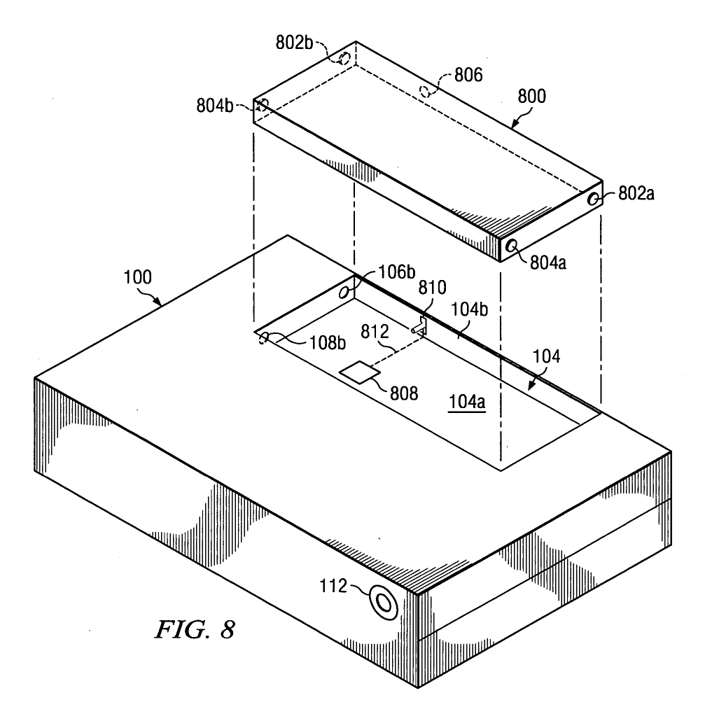

Referring to FIG. 8, there is shown a modification of the embodiment disclosed above, wherein laptop 100 is provided with a latching mechanism 810 joined to a wall of battery compartment 104. Latching mechanism 810 includes a hook member or the like for selectively engaging a complementary groove, eye or other structure formed in or attached to a battery intended for insertion into compartment 104.

FIG. 8 further shows such battery 800, with terminals 802a and 804a, together with complementary terminals 802b and 804b. Battery 800 is substantially identical to battery 200, described above, except that it is provided with a groove 806 or other structure, formed in or attached to its outer casing. Structure 806 is designed to be complementary to latching mechanism 810. More specifically, when battery 800 is moved into the battery exchange position, as shown by FIG. 4, the structure 806 will be brought into engagement with the hook of latching mechanism 810, and will be retained thereby. Thereupon, latching mechanism 810 will act to fixably hold the battery in the battery exchange position.

Referring further to FIG. 8, there is shown a depressible button or the like 808 located on surface 104a of battery compartment 104. Button 808 is selectively positioned so that when the replacement battery is initially inserted into battery compartment 104, as shown by FIG. 5, the button 808 is depressed downwardly, as viewed in FIG. 8. This movement of button 808 is coupled to the latching mechanism 810, by a mechanical linkage of conventional design represented in FIG. 8 by dashed line 812. Latching mechanism 810 is thereby operated to disengage or release battery 800, allowing battery 800 to be removed from compartment 104.

Alternatively, latch mechanism 810 could be electrically operated. For example, device 110 could be configured to detect the application of power through contact points 108a and b, when the replacement battery is first inserted into compartment 104 as shown by FIG. 5. Upon detecting such event, device 110 would generate a signal to electrically operate latching mechanism 810 to release the battery 800. The button 808 would still be available, to enable a laptop operator to manually release battery 800.

It will be readily apparent that by providing latching mechanism 810, together with related components as described above, the battery being replaced cannot be removed from the laptop computer until the replacement battery is in place. Accordingly, at least one battery will be supplying power to the laptop 100 at all times during the battery replacement procedure. Thus, the battery being replaced will not become disengaged from its contact points before the laptop user desires it to be.

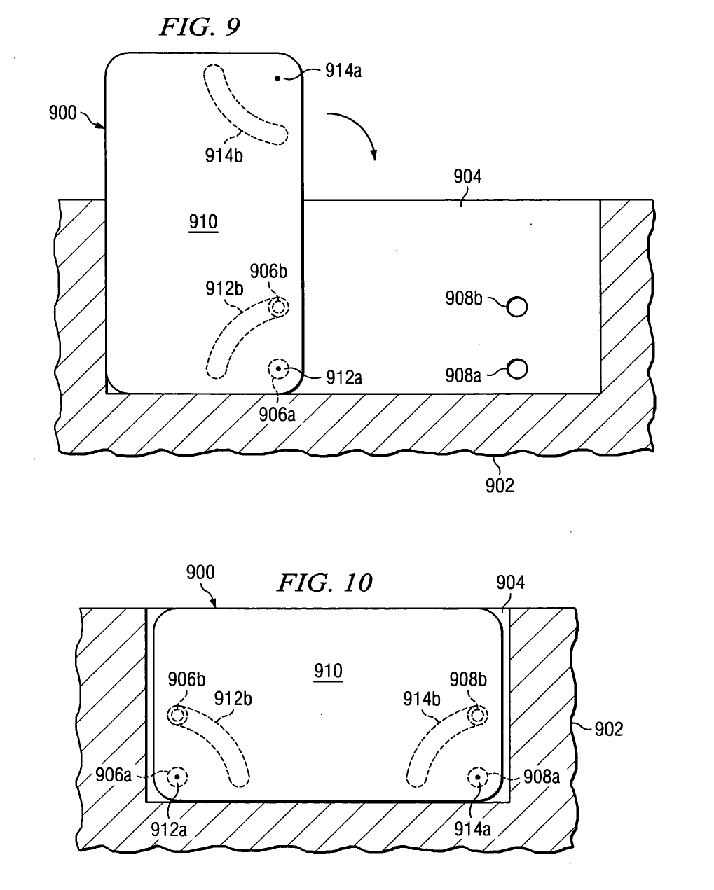

Referring to FIG. 9, there is shown a cutaway perspective view illustrating a further embodiment of the invention, wherein a battery 900 is inserted into a battery compartment 904 of an electronic device 902. In FIG. 9, battery 900 is positioned in compartment 904 in a first battery exchange position. Battery compartment 904 is provided with contact points 906a-b and 908a-b for receiving power from a battery or batteries inserted into compartment 904, in order to supply power to device 902.

Referring further to FIG. 9, there is shown battery 900 having a side 910 that usefully comprises a planar surface. Two pairs of battery terminals, 912a-b and 914a-b, are respectively mounted to a side of battery 900 opposite to side 910. Battery terminals 912a and 914a are positive terminals, and battery terminals 912b and 914b are negative terminals. However, in other embodiments of the invention the polarities of respective battery terminals could be opposite from those of battery 900. Moreover, terminals 912a and 914a are point terminals, whereas the terminals 912b and 914b are respectively formed to have specific curved configurations. Each terminal is formed of selected conductive material.

FIG. 9 further shows that when battery 900 is in the first battery exchange position, terminals 912a and 912b engage contact points 906a and 906b, respectively, in electrically conductive relationship. Sufficient power is thereby supplied from battery 900 to meet the power requirements of device 902. FIG. 9 also shows the terminals 914a and 914b of battery 900 to be disengaged and clearly separated from the contact points 908a and 908b.

It will be appreciated that in other embodiments of the invention, the contact points 906a-b and 908a-b could be mounted on battery 900 as the respective terminals thereof. The terminals 912a-b and 914a-b would be fixably mounted in compartment 904, to receive power from the battery mounted contacts 906a-b and 908a-b, respectively.

It is to be understood that battery 900 is configured for clockwise rotation from the first battery exchange position to a normal operating position, shown in FIG. 10. The axis of such rotation passes through battery terminal 912a and contact point 906a, so that these two elements remain engaged in conductive relationship during the rotation. Moreover, the curved shape of terminal 912b is judiciously selected so that conductive contact is maintained between terminal 912b and contact point 906b, as battery 900 is rotated from the first battery exchange position to the normal operating position. Thus, battery 900 continues to supply the power required for normal operation of device 902, as battery 900 is being moved to the normal operating position.

Referring further to FIG. 10, there is shown battery terminals 914a and 914b brought into engagement with contact points 908a and 908b, respectively, when battery 900 is moved into its normal operating position. Thus, in this position power is supplied by battery 900 through both terminal pairs 912a-b and 914a-b.

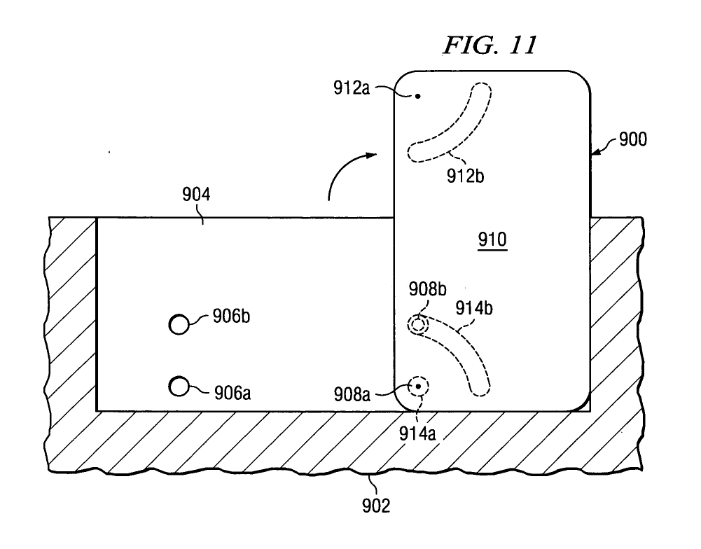

Referring to FIG. 11, there is shown battery 900 rotated from the normal operating position to a second battery exchange position. The axis of rotation passes through battery terminal 914a and contact point 908a, so that these two elements remain engaged in conductive relationship. Moreover, the curved shape of terminal 914b, in like manner with terminal 912b, is selected to maintain contact between terminal 914b and contact point 908b, as battery 900 is rotated from the normal operating position to the second battery exchange position. Thus, as this movement is being carried out, battery 900 continues to supply power required for normal operation of device 902 through terminal pair 914a-b.

After battery 900 has been moved to the second battery exchange position, a substantially identical battery (not shown) can be inserted into the first battery exchange position in battery compartment 904. Battery 900 can then be removed from compartment 904.

In a further embodiment of the invention, the system as described above can be used in tandem with an internal reserve battery setup provided in the laptop.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for providing at least a specified minimum level of power to an electronic device during a specified event, said system comprising:
a first battery having a plurality of terminal pairs, each terminal pair comprising a positive terminal and a negative terminal;
a battery interface comprising multiple pairs of contact points, the contact points of each pair adapted to selectively engage corresponding terminals of one of said terminal pairs in order to couple power from said first battery to said device, the power provided to said device by any one of said terminal pairs being sufficient to provide said minimum power level;
a structure configured to selectively support said first battery in normal operating and battery exchange positions with respect to said battery interface, and to further support said battery and said interface to maintain engagement between at least one of said terminal pairs and a contact point pair, whenever said battery is in one of said positions or is being moved therebetween; and
a second battery similar to said first battery, said second battery adapted for placement with respect to said structure to bring terminals of a terminal pair of said second battery into engagement with contact points of one of said contact point pairs, when said first battery is in said battery exchange position.

2. The system of claim 1, wherein:
said first battery has two of said terminal pairs, said battery interface has two of said contact point pairs, and the terminals of each terminal pair engage corresponding contact points of one of said contact pairs when said battery is in said normal operating position.

3. The system of claim 2, wherein:
the positive terminals of said terminal pairs are located on a first side of said battery, and the negative terminals are located on an opposing second side thereof; and
said structure is configured to enable said first battery to be moved from said normal operating position to said battery exchange position by rotating said first battery about an axis intersecting both the positive and negative terminals of a specified one of said terminal pairs.

4. The system of claim 3, wherein:
as said first battery is rotated from said normal operating position to said battery exchange position, the terminals of said specified terminal pair remain in engagement with respective corresponding contact points of one of said contact pairs, and the terminals of the other terminal pair are moved out of engagement with corresponding contact points of the other contact pair.

5. The system of claim 4, wherein:
said structure is configured to enable terminals of a terminal pair of said second battery to be moved into engagement with corresponding contacts of said other contact pair, when said first battery is in said battery exchange position.

6. The system of claim 5, wherein:
said specified event comprises replacing said first battery with said second battery in said normal operating position, with respect to said battery interface.

7. The system of claim 1, wherein:
a latching mechanism is joined to said structure for retaining the terminals of at least one terminal pair of said first battery in engagement with corresponding contact points of one of said contact pairs until said second battery is placed to bring terminals of one of its terminal pairs into engagement with corresponding contact points of another one of said contact pairs.

8. The system of claim 1, wherein:
the positive and negative terminals of at least one of said terminal pairs are both located on the same side of said first battery.

9. The system of claim 1, wherein:
said device comprises a laptop computer.

10. Apparatus for continuously providing at least a specified minimum level of power to a battery-powered device having a battery compartment, said apparatus comprising:
first and second pairs of contact points located in said battery compartment to receive power for operating said device;
a first battery having first and second terminal pairs, said battery adapted for selective placement into said battery compartment in a normal operating position and in first and second battery exchange positions;
said first terminal pair comprises positive and negative terminals configured to engage corresponding contact points of said first contact point pair, in order to supply power to said device when said first battery is in either said first battery exchange position or said normal operating position, or is being moved therebetween; and
said second terminal pair comprises positive and negative terminals configured to engage corresponding contact points of said second contact pair, in order to supply power to said device when said first battery is either in said normal operating position or said second battery exchange position, or is being moved therebetween.

11. The apparatus of claim 10, wherein:
a second battery that is substantially identical to said first battery is adapted for insertion into said compartment in said first battery exchange position, when said first battery is in said second battery exchange position.

12. The apparatus of claim 11, wherein:
said first battery is moved from said first battery exchange position to said normal operating position by rotating said first battery around an axis passing through both the terminals of said first terminal pair; and
said first battery is moved from said normal operating position to said second battery exchange position by rotating said first battery around an axis passing through both terminals of said second terminal pair.

13. The apparatus of claim 11, wherein:
positive and negative terminals of at least one of said terminal pairs are both located on the same side of said first battery.

14. The apparatus of claim 11, wherein:
said device comprises a laptop computer.

15. In a configuration wherein a first battery with multiple pairs of terminals is disposed to supply power to a device through a battery interface having multiple pairs of contact points, a method for replacing said first battery with a substantially identical second battery comprising the steps of:
moving said first battery from a normal operating position with respect to said battery interface to a first battery exchange position, while continuously maintaining engagement between the terminals of at least one of said terminal pairs and corresponding contact points of one of said contact point pairs;
inserting a second battery into a second battery exchange position, with respect to said battery interface, to bring the terminals of at least one terminal pair of said second battery into engagement with corresponding contact points of a contact point pair that are not engaged by terminals of said first battery;
removing said first battery from said first battery exchange position; and
moving said second battery from said second battery exchange position into said normal operating position.

16. The method of claim 15, wherein:
at least one terminal pair of said second battery continues to supply power to said device as said second battery is being moved from said second battery exchange position into said normal operating position.

17. The method of claim 16, wherein:
said first battery is provided with two of said terminal pairs, each comprising positive and negative terminals, said battery interface is provided with two of said contact pairs, and the terminals of each terminal pair engage corresponding contact points of one of said contact pairs when said battery is in said normal operating position.

18. The method of claim 17, wherein:
the positive terminals of said terminal pairs are located on a first side of said first battery, and the negative terminals are located on an opposing second side thereof; and
said first battery is moved from said normal operating position to said battery exchange position by rotating said first battery about an axis intersecting both the positive and negative terminals of a specified one of said terminal pairs.

19. The method of claim 17, wherein:
a latching mechanism is joined to said structure for retaining the terminals of at least one terminal pair of said first battery in engagement with one of said contact point pairs until said second battery has been inserted into said second battery exchange position.

20. The method of claim 17, wherein:
the positive and negative terminals of at least one of said terminal pairs are both located on the same side of said first battery.
